(19) United States
(12) Patent Application Publication
(10) Pub. No.: US 2012/0086295 A1
(43) Pub. Date: Apr. 12, 2012

(54) MOTORS WITH QUADRIC SURFACES

(75) Inventor: Chong Kyu Kim, Fort Lee, NJ (US)

(73) Assignee: MATRIX MOTOR, LLC, Fort Lee, NJ (US)

(21) Appl. No.: 12/898,801

(22) Filed: Oct. 6, 2010

(51) Int. Cl. H02K 1/06; H02K 23/40; H02K 15/16; H02K 17/02

(52) U.S. Cl. 310/166; 310/216.111; 310/177; 29/598

(57) ABSTRACT

A motor having a rotor whose outer surface conforms to a non-degenerate quadric surface, and a matching stator.

### BACKGROUND

The present invention relates to motors, in particular to motors with a rotor and a matching stator comprising non-degenerate quadric surfaces for higher energy efficiency, more balance and lower noise.

There are two main categories of motors available currently, alternating current (AC) motor and direct current (DC) motors. AC motors are commonly referred to, and will be referred to throughout this document, as induction motors.

Induction motors are widely used and are generally the preferred choice for industrial motors due to their simple, rugged construction, lack of brushes, low cost to manufacture, and the ability to control the speed of the motor. As shown in FIG. 1, a typical induction motor 100 comprises a rotor 102 (rotating part) and a stator 104 (stationary part). Unlike other motors, induction motors 100 have a rotor 102 that is not connected to an external source of voltage. The stator 104 consists of wound poles that carry the supply current that induces a rotating magnetic field in the conductor. Rotating magnetic fields in the stator 104 cause the rotor 102 to turn, and are the key to the operation of most alternating current motors. Because the rotor 102 is free to turn, it follows the rotating magnetic field in the stator 104.

To establish a rotating magnetic field in the stator 104, the number of electromagnetic pole pairs must be the same as the number of phases in the applied voltage. The pole pairs must be the same as (or a multiple of, i.e. 2, 4, 6, etc.) the number of phases in the applied voltage. The poles must be displaced from each other by an angle equal to the phase angle between the individual phases of the applied voltage. However, for these currents to be induced, the speed of the physical rotor 102 and the speed of the rotating magnetic field in the stator 104 must be different, or else the magnetic field will not be moving relative to the rotor 102 and no current will thus be induced. When this occurs, the rotor 102 typically slows slightly until a current is re-induced. This difference between the speed of the rotor 102 and speed of the rotating magnetic field in the stator 104 is called slip. Slip is the ratio between the relative speed of the rotating magnetic field as seen by the rotor 102 and the speed of the rotating magnetic field produced by the stator 104. Both of the two main types of rotors currently produced, squirrel-cage rotors and slip ring rotors, have slip to various degrees. Additionally, both types of rotors suffer from low starting torque, which is the ability to move the load that is attached to the motor.

The most common rotor is a squirrel-cage rotor 200, as shown in FIG. 2. It is made up of bars of either solid copper or aluminum that span the length of the rotor, and are connected through a ring at each end, forming a cage-like shape. The core of the squirrel-cage rotor 200 is built of a stack of silicon steel laminations. The conductors in this type of rotor, however, need to be skewed slightly along the length of the rotor to reduce noise and smooth out torque fluctuations that occur due to the interactions with pole pieces of the stator. The structure of this type of rotor also results in eddy current loss, requiring exotic materials and extra manufacturing to reduce the eddy current losses.

The squirrel cage rotor windings are employed to provide near-synchronous speed while the motor is starting. When a motor is operating at synchronous speed, the magnetic field is rotating at the same speed as the rotor, so no current will be inducted into the squirrel cage rotor 200 windings and it will have no further effect on the operation of the induction motor. Induction motors with squirrel cage rotors therefore generally must be combined with other means for rotating the rotors in addition to the squirrel cage rotor 200.

Slip ring motors are the other main type of rotor manufactured currently. As shown in FIG. 3, a slip ring rotor 300 makes an electrical connection through a rotating assembly. Slip ring rotors require the use of these slip rings, also called rotary electrical interfaces, rotating electrical connectors, collectors, swivels or electrical rotary joints, which consist of a conductive circle or band mounted on a shaft and insulated from it. Electricity is transferred from the rotor 300 to the slip ring using fixed contacts or brushes that are in contact with the slip ring. These contacts and/or brushes wear out over time, however, and need to be replaced. In addition, as the contacts and/or brushes wear out and collect debris and grit over time, the effectiveness of the electrical transfer diminishes. Friction induced by the contacts and/or brushes contacting the rotor reduces the motor's efficiency.

DC motors operate by placing a current-carrying conductor (an armature) in a magnetic field perpendicular to the lines of flux. The conductor then moves in a direction perpendicular to the magnetic fields interacting with each other. Voltage is transmitted through the armature coils by sliding contacts or brushes that are connected to a DC voltage source. The brushes are found on the end of the coil wires and make a temporary electrical connection with the DC voltage source. For example, in a single armature DC motor, the brushes will make a connection every 180 degrees and current will then flow through the coil wires. At 0 degrees, the brushes contact the DC voltage source and current flows through the armature interacting with the magnetic field that is present, resulting in an upward force on the upper armature segment and a downward force on the lower armature segment. Both the upward force and the downward force are equal in magnitude, but in opposing directions since the direction of current flow in the segments are reversed with respect to the stationary magnetic field. At 180 degrees, the same interaction occurs, but the lower armature segment is forced up and the upper armature segment is forced down. Disadvantageously, at 90 degrees and 270 degrees, the brushes are not in contact with the DC voltage source and no force is produced. At these two positions, the rotational kinetic energy of the DC motor keeps it spinning until the brushes regain contact.

A large amount of torque ripple is also produced by DC motors because the armature coil only has a force applied to the armature at the 0 and 180 degree positions. The rest of the time the coil spins on its own and the torque drops to zero. Therefore, more armature coils are required to smooth out the torque curve. The resulting torque curve never reaches zero, and the average torque is increased as more and more coils are added. However, the increase in torque is limited when the torque curve approaches a straight line and has very little torque ripple and the motor runs much more smoothly. Another method of increasing the torque and rotational speed of the motor is to increase the current supplied to the coils. This is accomplished by increasing the voltage that is sent to the motor, thus increasing the current at the same time.

A brushed DC motor generates torque directly from DC power supplied to the motor by using internal commutation, stationary permanent magnets, and rotating electrical magnets. The advantages of a brushed DC motor include low initial cost, high reliability, and simple control of motor speed. Disadvantages include high maintenance and low lifespan for high intensity uses. Maintenance involves regularly replacing the brushes and springs which carry the electric current, as well as cleaning or replacing the commutator.

### SUMMARY OF THE INVENTION

The present invention comprises an improved motor having a rotor whose outer surface conforms to a non-degenerate quadric surface and a matching shaped stator electromagnetically coupled to the rotor, which provides higher torque and better motor balance compared to prior motors due to its extended rotor surface, which attracts more of the available magnetic field and is a mathematically more stable geometrical shape. The motor can be an induction motor, a direct current motor and/or a universal motor. Preferably, the motor is an induction motor and comprises slots in the various curved shapes of the stator for accommodating a primary winding to generate a rotary magnetic field when electricity is applied to the primary winding. Such an induction motor can further comprise slots in the curved rotor for a secondary winding to generate a torque by an electromagnetic induction between the secondary winding and the primary winding when electricity is applied to the primary winding.

In an induction motor according to the present invention, the rotor and the stator preferably have surfaces with the same matched curvature shape, and this shape is preferably in parabolic, circular, or elliptical form. In one embodiment, the rotor of the induction motor can comprise a parabolic curve shaped rotor portion. The stator of the present induction motor can likewise comprise a parabolic curve shaped stator portion.

In one embodiment, the present induction motor has a stator that comprises a stator cage having three or more stator elements. The stator elements are each laminated, and each layer of lamination comprises a surface conforming to the shape of a non-degenerate quadric surface. Such a stator can further comprise wire coils looped around each of the stator elements to create electromagnets. In this embodiment, the stator elements are preferable electrically 120 degrees apart from each other.

In a further embodiment, the present motor is a direct current motor. The stator of such a direct current motor preferably comprises two or more electromagnetic field poles, and the electromagnetic field poles preferably comprise coils of insulated copper wire wound on conductive cores in a curved shape. This direct current motor can also include an armature rotor having a surface conforming to the shape of a non-degenerate quadric surface.

Preferably, the rotor and the stator of a DC motor according to the present invention have the same surface shape, which can for example comprise either a parabolic, circular or elliptical curve. Such a direct current motor can be manufactured directly from a curve shaped portion. The stator can likewise comprise a corresponding curve shaped portion.

### BRIEF DESCRIPTION OF THE DRAWINGS

FIG. 1 is a perspective view of a prior art alternating current induction motor.

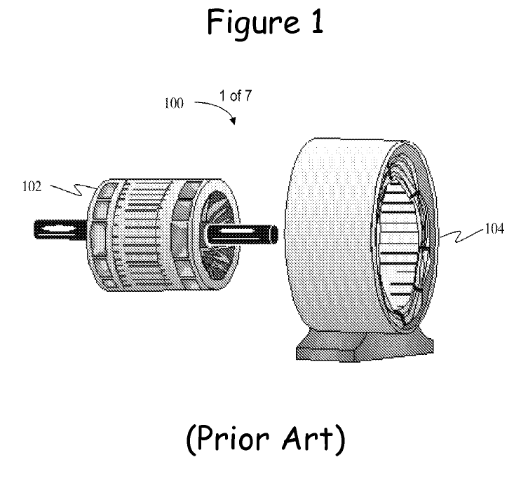

FIG. 2 is a perspective view of a prior art squirrel cage rotor.

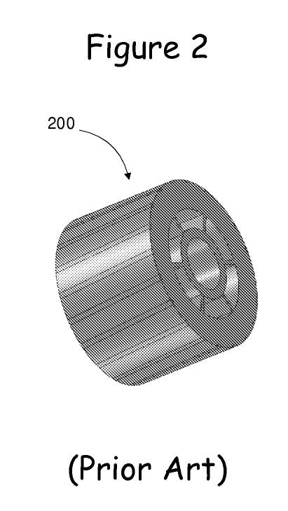

FIG. 3 is a perspective view of a prior art slip ring rotor.

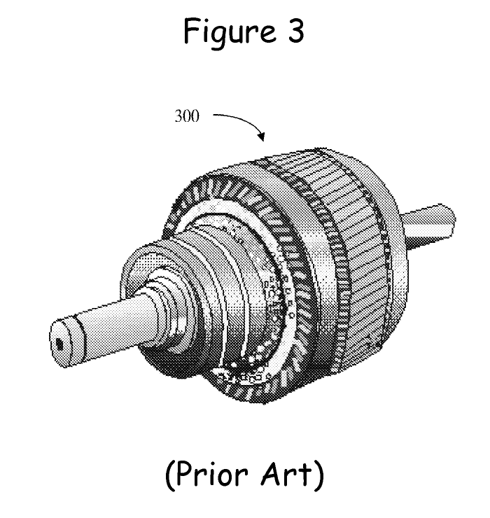

FIG. 4 is a graph of a torus and a parabolic curve.

FIG. 5A is a side view of a rotor comprising a quadric surface.

FIG. 5B is a top plan view of the rotor of FIG. 5A

FIG. 6 is a top plan view of a parabolic curve shaped stator according to one embodiment of the present invention.

FIG. 7 is a side view of a parabolic curve shaped rotor according to the embodiment of the present invention.

FIG. 8 is a sectional view of a parabolic curve shaped AC motor according to a further embodiment of the invention.

### DETAILED DESCRIPTION

In describing the features of this invention, the following terms and variations thereof are used, and such terms have the meanings given below, unless a different meaning is clearly intended by the context in which such term is used.

“Cage” refers to the short-circuiting end rings of a rotor that complete the “squirrel cage,” which rotates when a moving magnetic field induces current in the shorted conductors.

A “circular shape” refers to a three-dimensional shape made by rotating a circular (and its inverse function) curve around an x-axis in a Cartesian coordinate plane. Generally, the curve can be expressed in the form of (x−a)²+(y−b)²=r², where (a,b) is the center and r is the radius.

“Commutation” refers to the process by which a DC voltage output is taken from an armature that has an alternating current voltage induced in it.

An “elliptical shape” or “elliptical curve shape” refers to a three-dimensional shape made by rotating an elliptical (and its inverse function) curve around an x-axis in a Cartesian coordinate plane. The curve can be expressed in the implicit form of Ax²+Bxy+Cy²+1=0.

A “matching” surface as referred to herein means a surface having a curvature which is the same as or similar to the curvature of a matched surface, but which faces the opposite direction as compared to the matched surface, such that the matched surfaces can be placed in contact or in close proximity over all or a significant portion of their surface areas. An example of matched surfaces outside the scope of the present invention would be the surfaces of a ball and socket joint, in which the outer surface of the “ball” can be placed in contact with or in close proximity to the outer surface of the socket with which it is paired. Preferably, matched surfaces deviate in their curvatures by less than 20%, more preferably by less than 10%, and even more preferably by less than 5%. The present motors preferably comprise a rotor and stator that comprise matched surfaces, so that the rotor can rotate freely within the stator.

A “parabolic shape” or “parabolic curve shape” refers to a three-dimensional shape made by rotating a parabola (and its inverse function) curve around an x-axis in a Cartesian coordinate plane. Generally, the curve can be expressed in the form of Ax²+Bxy+Cy²+Dx+Ey+F=0, where B²=4AC, and A˜F are coefficients.

A “quadric surface” refers to a non-degenerate quadric surface, preferably a surface formed by revolving a conic section around one of its principle axes, including hyperboloids, elliptic paraboloids, and spheroids. A “conic section shape” as used herein refers to a quadric surface, specifically a three-dimensional shape made by rotating a conic section shaped curve (such as an ellipse or parabola) around an x-axis in a Cartesian coordinate plane.

“Rotor” refers to the rotating component of a motor typically constructed of a laminated, cylindrical iron core with slots for receiving conductors, such as, for example, cast-aluminum conductors or copper conductors.

“Stator” refers to a fixed part of a motor that does not rotate, typically consisting of copper windings within steel laminations.

A “surface,” e.g. of a stator or rotor, refers to the outer boundary of a component. Surfaces in this context need not be formed from a continuous piece of material, but can be comprised of the outer surfaces of coils, for example, which together form the outer surface of a component.

“Torus” refers to a surface of revolution generated by revolving a circle in three dimensional spaces about an axis co-planar with the circle, which does not touch the circle.

“Winding” refers to a coil or coils, typically made of copper wire, wrapped around a core, usually of steel. In an alternating current induction motor, a primary winding is the stator, typically consisting of wire coils inserted into slots within steel laminations. A secondary winding of an alternating current induction motor is typically the rotor, although a secondary winding can also be formed by additional wire coils inserted into the slots of the stator.

“Universal motor” refers to a motor that can use either an alternating current power supply or a direct current power supply.

The term “comprise” and variations of the term, such as “comprising” and “comprises,” are not intended to exclude other additives, components, integers or steps. The terms “a”, “an,” and “the” and similar referents used herein are to be construed to cover both the singular and the plural unless their usage in context indicates otherwise.

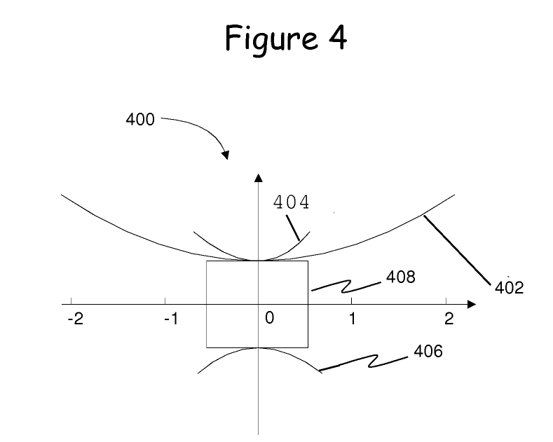

Referring now to FIG. 4, there is shown a graph 400 of a torus 402 and a parabolic function of a parabolic curve 404 and 406. A square 408 is graphed at the point (0.5,0.5) on the Cartesian plane to better illustrated the plotted curve functions. An arc portion of the torus circle 402 can be set to match the parabolic or inverse parabolic function. The range of the arc point is located at 0 to 0.5 of the x-axis. This mathematical function shows that the parabolic with different parameters can be embedded directly into the torus at the lower range. As can be seen, the arc of the parabolic function 404 fits into a portion of the torus circle 402. The arc of the circle that is formed in the torus circle 402 is a parabolic function, and more particularly a parabolic functional line 404. The torus 402 and the parabolic function 404 are two different shapes, but share a common arc point of the circle at Cartesian coordinates 0 to 0.5 on the x axis of the graph if we can precisely adjust the parameters. Note that the parabolic function is one of the functions that can be used in the present motor and is used here for explanatory purposes.

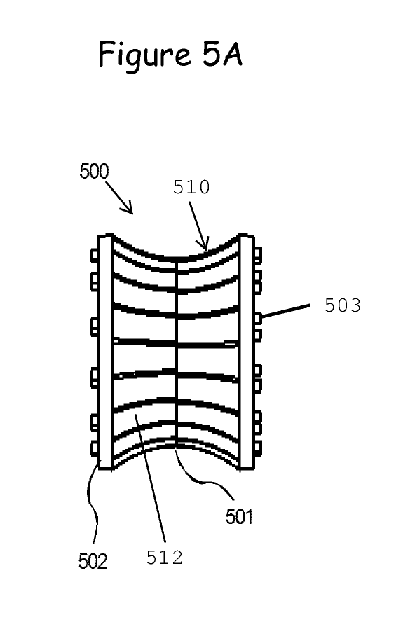

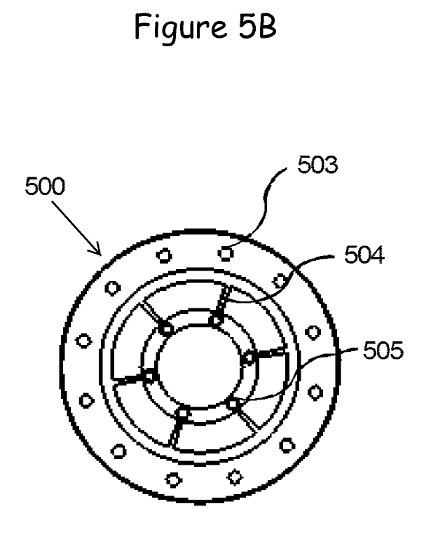

Referring now to FIG. 5, there is shown an illustration of a rotor 500 having an outer surface that conforms to a non-degenerate quadric surface, including both side view and top view. Since more magnetic energy is harvested by the present motors than by conventional motors, there is a clear advantage for increasing the torque. In addition, a symmetrically curved revolutionary body such as the present rotor will have a better rotation-balancing ability both horizontally and vertically.

In the embodiment shown in FIG. 5A, the rotor 500 comprises two individual parts 510 with a gasket 501 in between and can be made up of a plurality (e.g., hundreds) of laminated silicon steel sheets piled together. The major function of the gasket 501 is to assure the strict and tight connection of the two separate parts 510 through quasi-hydraulic pressing machine. In addition, there are two identical covers 502, which can play the same role as the metal ring in squirrel cage rotor. An aluminum bar 503 is also preferably included in the present motor in order to generate and conduct current. To further reduce the weight of the rotor 500, a bolstering bar 504 (FIG. 5 B) can be used instead of bulk material. Bolts 505 are used to further fasten the connection between the two separate parts 510 of the rotor 500 and make sure there's no chance to be apart during the rotation of the rotor 500.

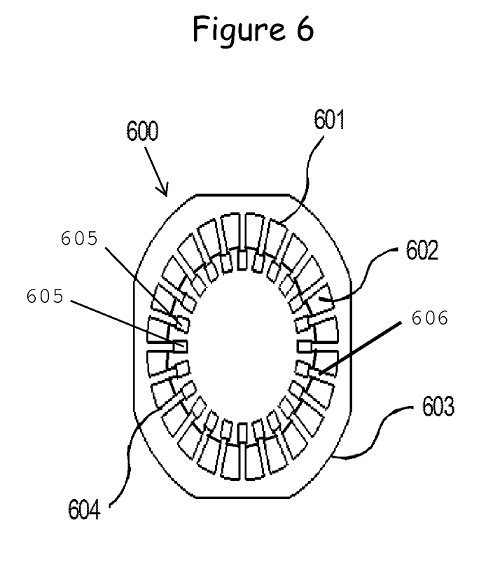

Referring now to FIG. 6, there is shown an illustration of a stator 600 having an inner surface 605 that conforms to a non-degenerate quadric surface. As applied to the inner surface of a stator and/or to the outer surface of a rotor of the present invention, the term “conform” means that the surface of the rotor or stator comprises the same shape as the referenced quadric surface over at least a portion of its surface area. Preferably, such surfaces are conforming over at least 50% of their surface area, more preferably over at least 70% of their surface area, and even more preferably over at least 90% or 100% of their surface area. In a preferred embodiment, the surface of a rotor or stator having a non-degenerate quadric surface is a continuous surface. The outer surface 512 of the rotor 500 of FIG. 5A, for example, exemplifies such a continuous surface. Alternatively, rotors and/or stators can comprise outer and inner surfaces, respectively, formed from discontinuous segments or portions which conform to the boundaries of a non-degenerate quadric surface. In aggregate, the relevant surfaces in such a rotor or stator thus comprise a non-degenerate quadric surface, but in a discontinuous fashion. FIG. 6 exemplifies a stator 600 comprising segments 606 whose inner surfaces 605 conform to a non-degenerate quadric surface.

The surfaces of the present rotors and stators that comprise non-degenerate quadric surfaces preferably conform to (match) a non-degenerate quadric surface shape precisely, i.e. they have the shape defined by the relevant mathematical function (an ideal shape). However it is to be understood that differences in the diameters of the present rotors, stators, or portions thereof can differ from the shape of a non-degenerate quadric surface or its inverse by up to 10% over the portion of the present rotor or stator that comprises a non-degenerate quadric surface, such that the surface of a rotor or stator can be closer to or further from an axis of rotation of the rotor or stator by up to 10%, in which case the distance between an axis of rotation of the rotor-stator assembly and the surface of the rotor or stator is greater than or less than a mathematically derived non-degenerate quadric surface by 10% at a given point. Such differences and deviations may result from manufacturing tolerances or from other design parameters in particular embodiments. Preferably, rotor and stator surfaces deviate by less then 5% from a mathematically derived non-degenerate quadric surface, more preferably by less then 2%, and even more preferably by less than 1%.

In one embodiment of the present invention, only the rotor of the present motor comprises a surface having a non-degenerate quadric surface, which provides greater balance to the assembly during rotation of the rotor. In order to achieve the maximum efficiency and torque from the assembly, however, preferably both the rotor and stator comprise surfaces having a non-degenerate quadric surface, i.e. such that the stator comprises a non-degenerate quadric surface that matches the non-degenerate quadric surface of the rotor.

In the embodiment of FIG. 6, stator elements 606 that are laminated from a cut metal sheet comprising a parabolic curve. In one embodiment, a wire coil can be looped around each stator element 606 to create electromagnets that are electrically 120 degrees apart, for a three phase motor. The inner contour is determined by the dimension of circle 601 and the outer shape is decided by the dimension of the arc and line 603. Space 602 is designed for containing the bunch of wires while intervals 604 separate different bunches of wires. Note that the wire coil can either be looped from inside the stator and outside the stator.

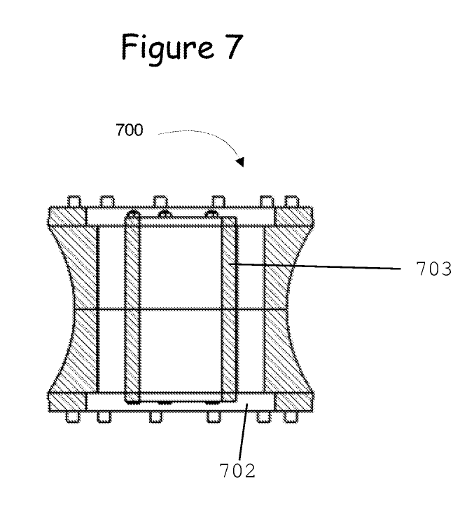

Referring now to FIG. 7, there is shown a sectional view of a parabolic shaped rotor 700 according to an embodiment of the present invention. Parabolic curve shaped rotors and stators are preferably solid. The aluminum bars 703 and cover rings 702 are cast through aluminum liquids. As mentioned above, the present non-degenerate quadric surface shaped rotor and stator together provide more torque and better balance than a traditional cylinder shaped rotor. Additionally, the outer radial portion of a parabolic shaped rotor such as that illustrated in FIG. 7 provides more balance to the motor. Therefore, thick copper wire can be placed on the surface of a laminated steel disk that is curved along a parabolic function to provide the induction between the rotating magnetic field of both stator and rotor.

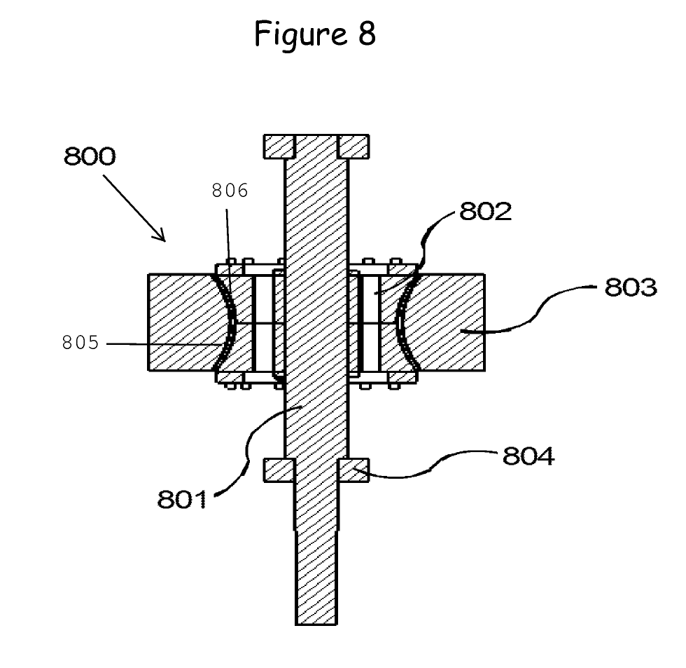

Referring now to FIG. 8, there is shown a sectional view of a fully assembled non-degenerate quadric surface shaped motor 800. Current AC motors comprise a propelling shaft 801, rotor 802, stator 803 and a pair of bearings 804. In the illustrated embodiment, the stator 803 of the present motor contains two or more electromagnetic field poles, which can comprise coils of insulated copper wire wound on conductive cores, for example in a parabolic curve shape. In the case of a direct current motor of the present invention such a motor also comprises an armature rotor having a non-degenerate quadric surface shape, such as a parabolic curve shape.

In a preferred embodiment, the outer surface or surfaces of the rotor and stator of the present motor have the same non-degenerate quadric surface shape, but correspond to opposite facing surfaces of such a shape. The surface of a rotor of the present motor that faces the stator is thus preferably the inverse of the surface of the stator that faces the rotor. In the embodiment illustrated in FIG. 8 for example, inner surface 805 of the stator 803 comprises the inverse shape as compared to the outer surface 806 of the rotor 802. The assembling process for the motor shown in FIG. 8 can comprise five major steps, i.e. (i) using a CNC machine or water jet to cut pieces of laminated silicon steel sheets and piling them to form a half parabolic rotor 802, (ii) making stator piece according to the matching shape of rotor and then piling them into a stator 803, (iii) putting one half of the rotor first using a CNC positioning machine and compressing two halves of parabolic rotor together with a gasket in between by hydraulic machine, (iv) installing bolts into the pre-made holes to further fix the two parts, and (v) inserting the propelling shaft 801 into the rotor and putting the accompanying bearings 804.

Although the present invention has been discussed in considerable detail with reference to certain preferred embodiments, other embodiments are possible. The drawings and the associated descriptions are thus provided to illustrate embodiments of the invention and not to limit the scope of the invention. The steps disclosed for the present methods are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A motor comprising:
a rotor having an outer surface that comprises a non-degenerate quadric surface shape; and
a stator, the rotor being electromagnetically coupled to the stator.

2. The motor of claim 1, wherein the stator has an inner surface, the inner surface comprising a shape that matches the non-degenerate quadric surface shape of the rotor.

3. The motor of claim 1, wherein the non-degenerate quadric surface is selected from the group consisting of an elliptic paraboloid, a spheroid, and a hyperboloid.

4. The motor of claim 1, wherein the non-degenerate quadric surface shape of the rotor differs from the shape of an ideal non-degenerate quadric surface by up to 10%.

5. The motor of claim 1, wherein outer surface of the rotor conforms to the non-degenerate quadric surface shape over at least 50% of the surface area of the rotor.

6. The motor of claim 1, wherein outer surface of the rotor conforms to the non-degenerate quadric surface shape over at least 90% of the surface area of the rotor.

7. The motor of claim 1, wherein the motor is selected from the group consisting of an AC (induction) motor and a DC motor.

8. The motor of claim 1 wherein the motor is an induction motor, further comprising slots in the inner surface of the stator for accommodating a primary winding to generate a rotary magnetic field when electricity is applied to the primary winding.

9. The motor of claim 8, further comprising slots in the outer surface of the rotor for a secondary winding to generate a torque by an electromagnetic induction between the secondary winding and the primary winding when electricity is applied to the primary winding.

10. The motor of claim 1, wherein the motor is an induction motor, where the stator further comprises:
a) a stator cage comprising 3 or more stator elements, wherein the stator elements are each laminated, and wherein each layer of lamination comprises a non-degenerate quadric surface shape; and
b) wire coils looped around each of the stator elements to create electromagnets.

11. The motor of claim 10, wherein the stator elements are electrically 120 degrees apart from each other.

12. The motor of claim 1, wherein the motor is a DC motor, and wherein the stator further comprises two or more electromagnetic field poles which comprise coils of insulated copper wire wound on conductive cores in a complete curve shape.

13. The motor of claim 1, wherein the motor is an DC motor, further comprising an armature rotor having a corresponding complete curve shape.

14. A method of constructing a motor for better torque and balance, comprising the steps of:
a) providing a stator having an inner surface that conforms to a non-degenerate quadric surface and having a longitudinal extent comprising two ends;
b) providing a rotor having an outer surface that conforms to a non-degenerate quadric surface, wherein the inner surface of the stator matches the outer surface of the stator;
c) providing a weight balanced flywheel to balance the vertical magnetic force; and
d) aligning the stator and the rotor to balance the motor.

15. The method of claim 14, wherein the motor is a vertical induction motor.

16. The method of claim 14, wherein the motor is a horizontal induction motor.

17. The method of claim 14, wherein the motor is a vertical DC motor.

18. The method of claim 14, wherein the motor is a vertical DC motor.
